(19) United States
(12) Patent Application Publication
(10) Pub. No.: US 2010/0030628 A1
(43) Pub. Date: Feb. 4, 2010

(54) Monitoring Vehicle Use

(75) Inventors: Simon Robert Renshaw-Smith, Sheffield (GB); Martyn Ian Attwood, Sheffield (GB)

Correspondence Address: RICHARD M. GOLDBERG, 25 EAST SALEM STREET, SUITE 419, HACKENSACK, NJ, 07601, US

(73) Assignee: ANPR INTERNATIONAL LIMITED, Sheffield (GB)

(21) Appl. No.: 12/505,097

(22) Filed: Jul. 17, 2009

(30) Foreign Application Priority Data
Jul. 17, 2008 (GB) 0813101.3
Dec. 1, 2008 (GB) 0821858.8

(51) Int. Cl. G06Q 50/00

(52) U.S. Cl. 705/13

(57) ABSTRACT

A method of monitoring car parking obtains entry data containing at least one entry record, and exit data containing at least one exit record, wherein each entry/exit record contains a vehicle registration number and an entry/exit time. Entry and exit records that have the same vehicle registration number are matched to produce at least one parking record, wherein each parking record contains a vehicle registration number and an indication of a time stayed. Payment data containing at least one payment record is obtained, wherein each payment record contains a vehicle registration number and an indication of a period of time corresponding to a fee paid. For each parking record, either a payment record is identified that has the same vehicle registration number. It is determined whether the indication of time stayed exceeds the period of time in the identified payment record, or if there is no matching payment record identified.

### BACKGROUND OF THE INVENTION

1. Field of the Invention

The present invention relates to apparatus and a method for monitoring vehicle use, in particular use of car parking sites.

2. Description of the Related Art

It is known to provide car parking sites in which vehicles may be parked. Typically, either parking must be paid for or the duration of parking is limited. Free car parks often have a no-return period during which a vehicle that has already parked may not return. These car parking sites must be monitored by a traffic warden or similar to ensure that parking regulations are complied with. However, it is expensive to provide each site with its own warden, and if a warden covers more than one site it is possible for vehicles contravening the local parking regulations to have left the site before they are discovered. This leads to misuse of car parking sites.

Camera systems for monitoring vehicle movements, such as bus lane cameras and speed cameras, are known. However, these rely on human operators to correlate the data they produce. Again, either many operators must be employed in order to catch every offender, or some offenders are not caught.

### BRIEF SUMMARY OF THE INVENTION

According to an aspect of the invention, there is provided apparatus for monitoring a car park as provided by claim 1.

### BRIEF DESCRIPTION OF THE SEVERAL VIEWS OF THE DRAWINGS

FIG. 1 illustrates a car parking site;

FIG. 2 shows an environment in which the invention may be employed;

FIG. 3 shows the central server shown in FIG. 2;

FIG. 4 details the contents of the memory shown in FIG. 3;

FIG. 5 details a camera system shown in FIG. 2;

FIG. 6 illustrates a pay-and-display machine shown in FIG. 1;

FIG. 7 details a database held on the storage shown in FIG. 3;

FIG. 8 shows files held on the storage shown in FIG. 3;

FIG. 9 details steps carried out by the monitoring application shown in FIG. 4 to monitor car parking;

FIG. 10 details steps carried out during FIG. 9 to create the parking table shown in FIG. 7;

FIG. 11 details steps carried out during FIG. 9 to identify certain vehicles permitted to park;

FIG. 12 details steps carried out during FIG. 9 to match records in the parking table shown in FIG. 7 with records in the payment table shown in FIG. 7;

FIG. 13 details steps carried out during. FIG. 12 to perform error checking;

FIG. 14 details: steps carried out during FIG. 9 to analyse records in the parking table shown in FIG. 7; and

FIG. 15 details steps carried out during FIG. 14 to create a charge notice.

### DESCRIPTION OF THE BEST MODE FOR CARRYING OUT THE INVENTION

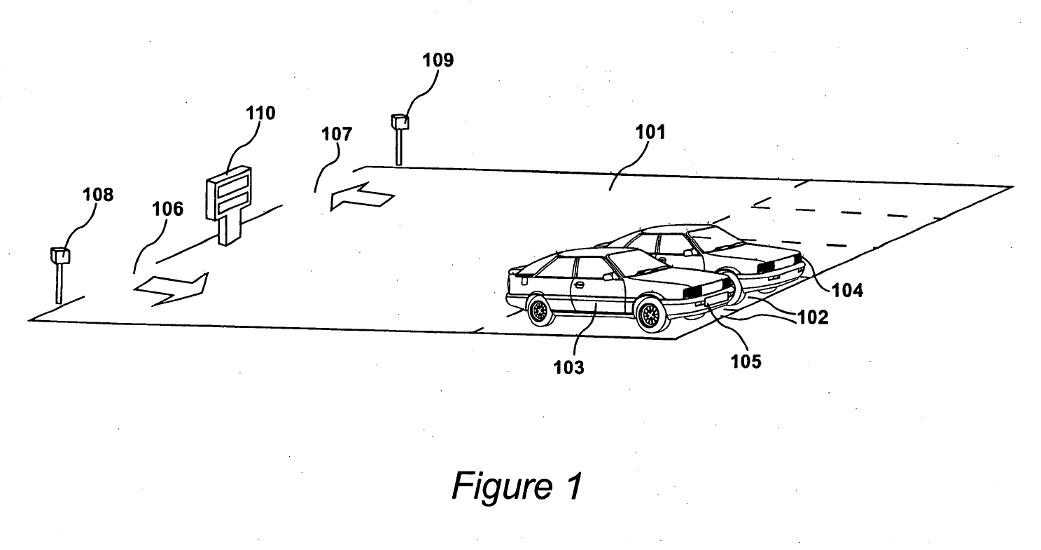

### FIG. 1

A car parking site suitable for being monitored by the system described herein is shown in FIG. 1. Car park 101 includes a plurality of car parking spaces 102, in which vehicles such as cars 103 and 104 may be parked. Each vehicle bears a vehicle registration number that is unique within its registration authority; for example car 103 has a registration number plate 105 displaying its registration number.

The car park has an entry lane 106 and an exit lane 107. These may have barriers or be barrier-free. Each. lane is monitored by a device suitable for reading number plates, in this example a camera; thus entry lane 106 is monitored by camera 108 and exit lane 107 is monitored by camera 109. Cameras 108 and 109 are configured to automatically read vehicle registration number plates such as plate 105 in order to log the times at which a vehicle enters and exits car park 101.

A payment device is provided by pay-and-display machine 110, that allows the driver of a vehicle such as vehicle 103 to pay for the use of car park 101. On entering car park 101. and parking, the driver goes to pay-and-display machine 110, enters the vehicle's registration number, pays a fee, and is provided with a time by which the car 103 must leave car park 101.

The system is also suitable for monitoring car parks that do not have pay-and-display machines, but allow a maximum duration of parking, possibly with a no-return period.

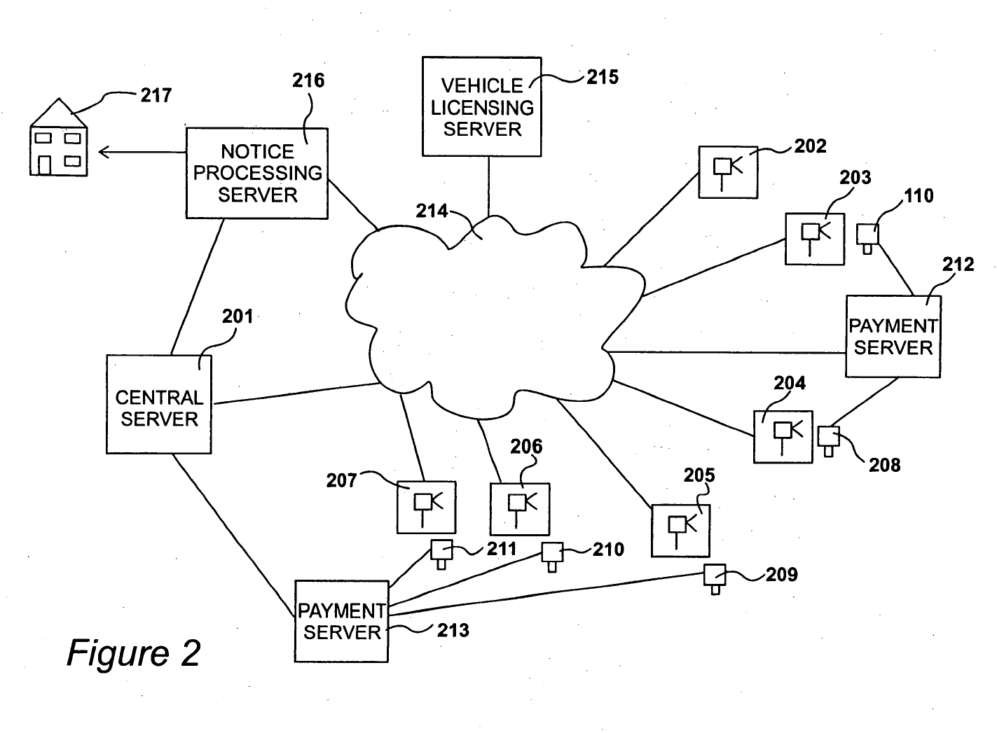

### FIG. 2

Central server 201 monitors the car parking site shown in FIG. 1. The server can monitor a single site, but it is cost-effective to use it to monitor a plurality of car parking sites, each of which has a camera system comprising at least one camera. Thus camera systems 202, 203 comprising cameras 108 and 109, camera system 204, camera system 205, camera system 206 and camera system 207 are each located at a different car parking site.

Each site may also have a payment device such as a pay-and-display machine. For example, pay-and-display machine 110 is located at the same site as camera system 203, and pay-and-display machines 208, 209, 210 and 211 are located at the same sites as camera systems 204, 205, 206 and 207 respectively. Each pay-and-display machine is connected to a payment server. Pay-and-display machines 110 and 208 are connected to payment server 212, and pay-and-display machines 209, 210 and 211 are connected to payment server 213. Each payment server stores transactions carried out by pay-and-display machines connected to it. Typically, each pay-and-display machine is connected to its payment server by a telephone line or mobile telephony network, but other connection methods are also possible. The site at which camera system 203 is located is a non-paying car park and does not have a payment device.

Central server 201, camera systems 202 to 207, and payment server 213 are all connected to the Internet 214 by ADSL lines. Using a virtual private network, central server 201 can obtain data from the camera systems and payment server. Additionally, payment server 212 is directly connected to central server 201 via a local area network, allowing central server 201 to access the data held on it. By comparing all of these data, central server 201 can determine. whether a particular vehicle contravened local parking regulations, ie the regulations that apply to the car parking site in which the vehicle parked. If this is the case, then central server 201 can forward the vehicle and contravention details to notice processing server 216, which is connected to central server 201 by a local area network. Notice processing server 216 requests registration details for the vehicle from vehicle licensing server 215 and on receipt produces a charge notice and sends it to the keeper of the vehicle, typically to his postal address 217. Notice processing server 216 and vehicle registration details 215 are both connected to the Internet 214 by an ADSL line and communication between them takes place over a secure data link.

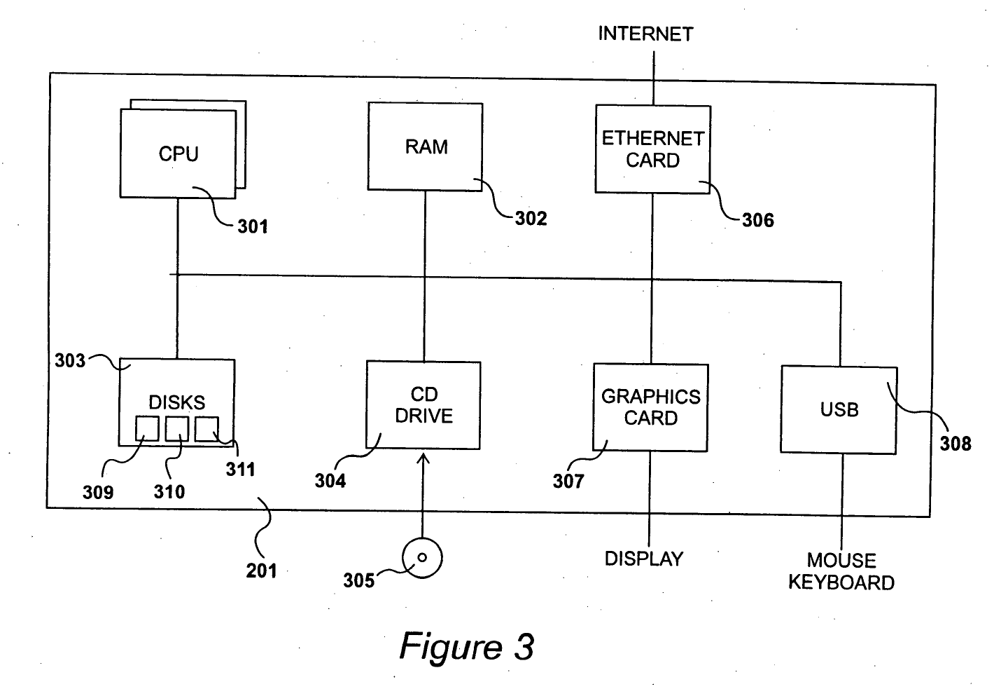

### FIG. 3

Central server 201 is detailed further in FIG. 3. In this embodiment, a processor is provided by a dual core central processing unit 301 having a clock frequency of 2 GHz, memory is provided by main memory 302 comprising 8 GB of dynamic RAM, and storage is provided by a 1TB disk array 303. A CD-ROM disk drive 304 allows instructions to be loaded onto local storage 303 from a CD-ROM 305. A network connection is provided by Ethernet card 306, which facilitates connection to Internet 214 via an ADSL router and firewall proxy server (not shown). A graphics card 307 provides display data to an optional display device, while a USB input/output interface 308 provides connectivity for manual input devices such as a mouse or keyboard, if required.

Stored on disk array 303 is a database 309 that contains records of parking and payment details, files 310, including for example lists of vehicles that are permitted to park at certain sites, parking regulations, and so on, and JPEG image files 311 that contain images captured by cameras such as cameras 108 and 109.

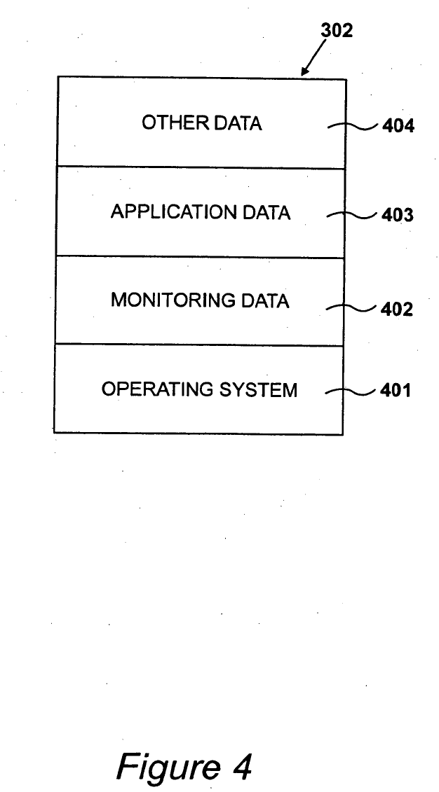

### FIG. 4

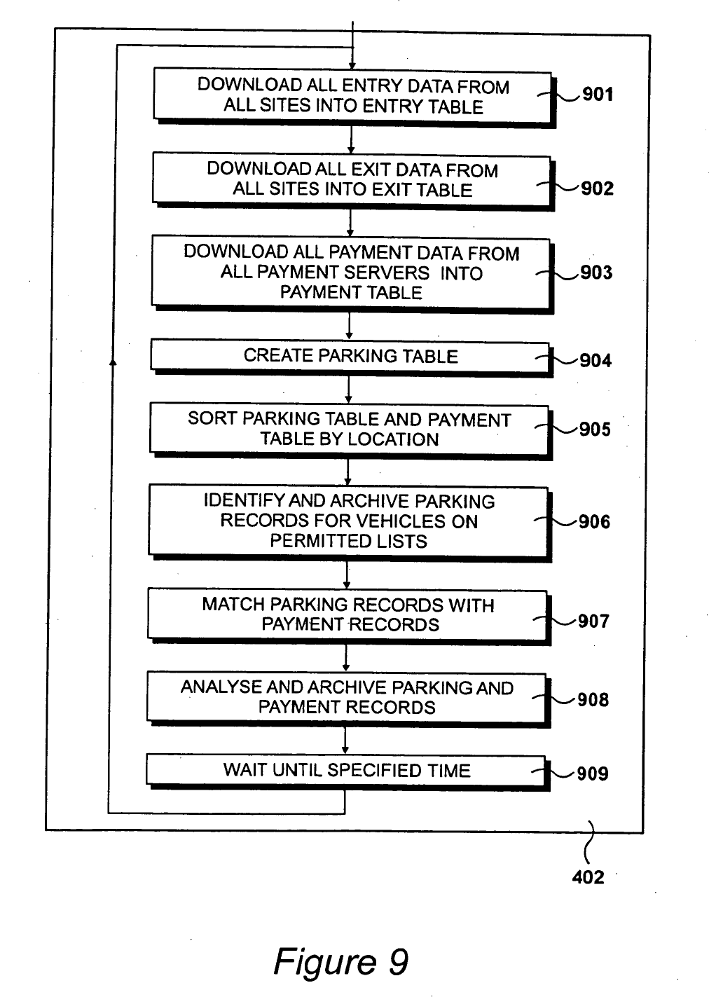

The contents of main memory 302 are detailed in FIG. 4. An operating system 401 provides operating system instructions for common system tasks and device abstraction. In this embodiment, the UNIX operating system is used, but any suitable operating system could be used. Monitoring application instructions 402 configure processor 301 to monitor car parking sites, as will be described further with reference to FIG. 9. Application data 403 is data used by the application 402, and other data 404 is used by other applications and the operating system 401.

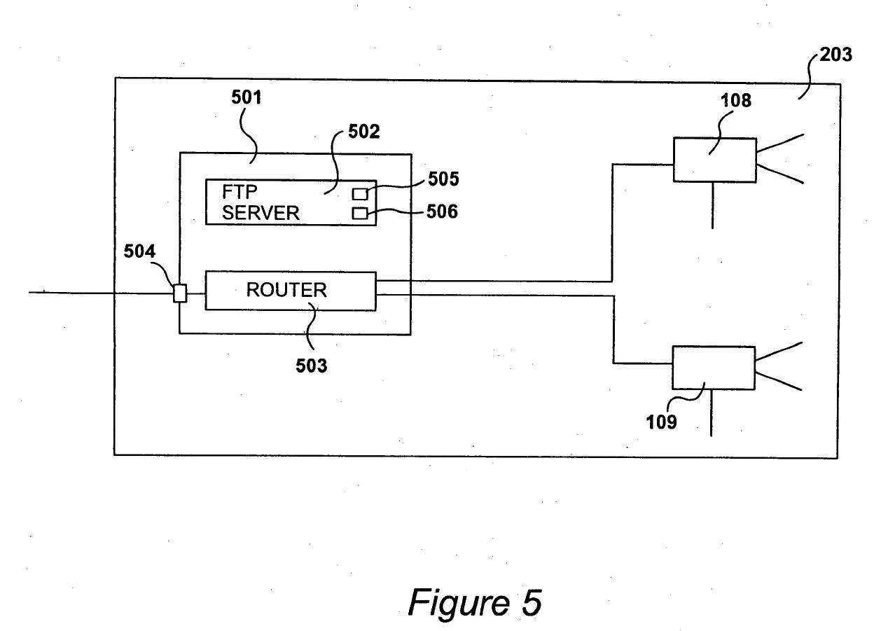

### FIG. 5

FIG. 5 details camera system 203, which comprises cameras 108 and 109 as shown in FIG. 1. Camera system 203 further comprises a local storage device 501, comprising an FTP server and processor 502 and an ADSL router with firewall 503. Router 503 provides connectivity via an ADSL socket 504 to the Internet 214, and also connects FTP server 502 and cameras 108 and 109 via a local area network, either through cables or wireless.

Data collected by cameras 108 and 109 is stored in a hard disk drive on FTP server 502 as data 505, including CSV data and JPEG images, until downloaded by central server 201. The data could also be in XML, ASCII or another format. Also stored on the server is a watch list 506 of vehicle registration numbers that the system should monitor and take a predetermined action: when the vehicle is identified. If the cameras see any of these registration numbers then a range of actions can be taken, such as ?raising a barrier to allow a permitted vehicle into or out of the car park, or sending an alert to a monitoring centre, police, local authority or parking enforcement service, for example by email or SMS. This provides a method of tracking and monitoring specific vehicles.

In other embodiments the FTP server could have one or more solid state disks rather than disk drives. In further embodiments, each camera could have an embedded FTP server rather than being connected to a local storage device. In that case each camera could still be connected to the Internet via a router or each could have its own ADSL line. As a further alternative, the cameras could send the data they collect immediately to central server 201 via a leased line, but this is more expensive than using a virtual private network over the Internet.

In this embodiment, each of cameras 108 and 109 is an Automatic Number Plate Recognition (ANPR) camera. An ANPR camera continuously scans its field of view, typically taking 20 images per second, and upon seeing an object that resembles a number plate it determines the location of the object within the image, captures just the number plate and scans the captured image using optical character recognition to obtain the characters written thereon. The number plate is then tracked in order that it is not recaptured again before it leaves the field of view. Thus, the data 505 stored on FTP server 502 comprises a plurality of records, each record being a time (including the date), an identification of the camera as being an entry or exit camera at a particular car parking site, a vehicle registration number, and the image from which the number was read. Another type of device capable of reading a number plate could be used.

All vehicle number plates in the field of view will be processed. However, tailgating could mean that number plates are not seen by the camera. To avoid this, automatic barriers that only permit one vehicle to enter or exit at a time could be used. The barrier could have a sensor, or there might be a sensor embedded in the road, or alternatively the barrier could lift if a camera sees a number plate. Alternatively, speed bumps could reduce tailgating.

The minimum requirement for a camera system is a single camera monitoring both the entry and exit lanes of a car park. However, the placement of such a camera can be difficult and thus having an entry camera and an exit camera is generally preferred.

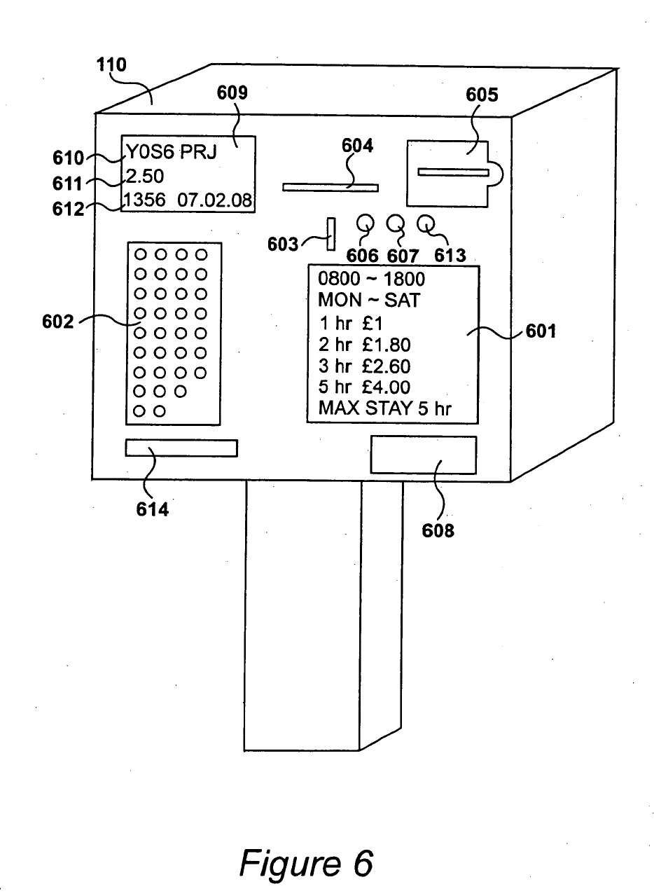

### FIG. 6

Pay-and-display machine 110 is illustrated in FIG. 6. Pay-and-display machines 208, 209, 210 and 211 are substantially similar. The machine has local parking regulations 601 (also referred to as terms and conditions) written upon it, specifying, in this example, the times of day and days of the week at which parking must be paid for, the cost of parking, and the maximum stay possible. By parking, the driver contracts not to contravene (or breach) these regulations. When the driver of a vehicle has parked in the car park, he enters the vehicle's registration number using alphanumeric keypad 602. He then pays for his parking by putting coins or tokens into coin slot 603, bank notes into bank note slot 604, or using a credit card or other payment card in card reader 605. If he makes a mistake, he can press the cancel button 606, or the coin return button 607. Coins are returned into slot 608.

Machine 110 includes a visual display 609 on which is shown the registration number 610 that has been input, the amount of money 611 that has been paid, and the time and date 612 by which the vehicle must leave the car park, calculated in accordance with the amount paid and the maximum stay. If the driver is satisfied, he presses button 613 and a ticket is issued from slot 614. This operates as a receipt should the driver need to prove that the parking was paid for.

Each transaction is saved as parking data on parking server 213 comprising the time and date, fee, registration number, duration of time paid for, and an identification of the pay-and-display machine. The data is sent to parking server 213 in CSV and ASCII format and is saved there in a SQL database. Other data formats may be used.

In an alternative embodiment, a payment device could be provided by a mobile telephone or similar mobile device using SMS or WAP, a landline telephone using key-presses or voice activation, an internet-connected booth, or some other method of transmitting payment and registration details to a payment server. Instead of putting money in a pay-and-display machine, a user account or credit/debit card would be debited, or some other method of obtaining the payment would be used Because the system described herein has no need for traffic wardens, it is not necessary for a driver to display proof of payment in the windscreen of the vehicle, as with conventional pay-and-display car parks, and therefore an actual printed ticket need not be produced since some form of electronic receipt can be issued.

As an alternative to immediate payment, some form of verification of identity could be used. For example, biometric data or a PIN could be entered by a driver who has paid for parking in advance or is otherwise permitted to park.

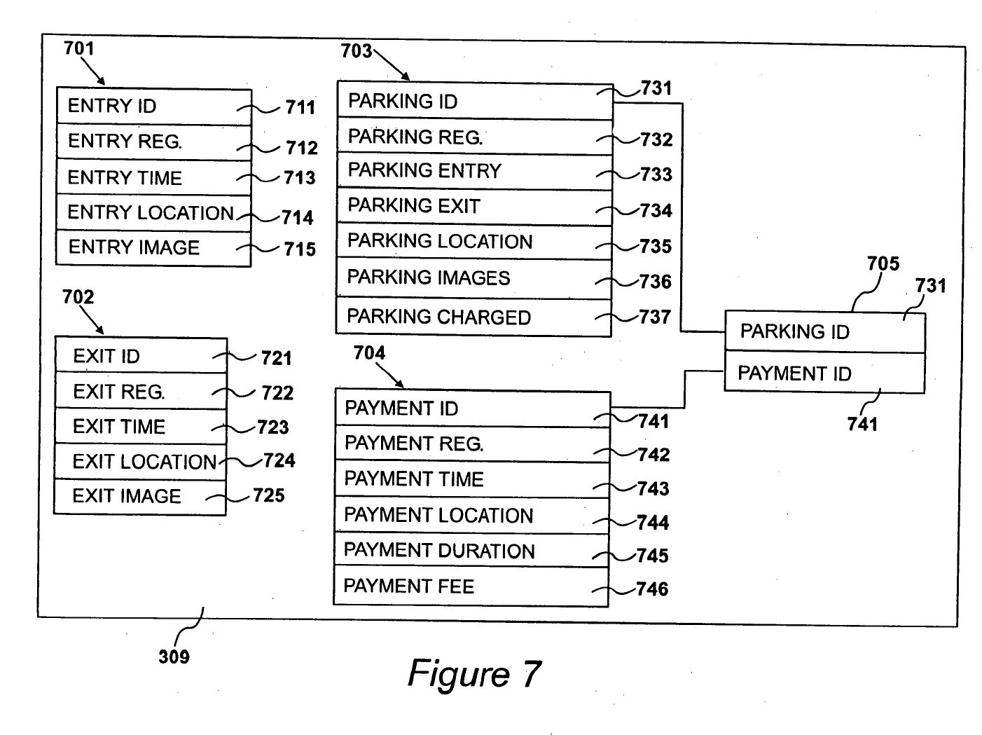

### FIG. 7

FIG. 7 details database 309. Five of the tables in the database are shown. Entry table 701 contains details of vehicle registrations captured by cameras sited at entry lanes of car parks, such as camera 108. Table 701 comprises several fields, including entry ID field 711, entry registration field 712, entry time field 713, entry location field 714, and entry image field 715, which is a pointer to one of image files 311. Thus the table contains a plurality of entry records, each indicating a vehicle registration number, a time at which the vehicle registration number plate was seen, the location of the camera and an indication of where the image of the number plate, can be found.

Similarly, exit table 702 comprises all the data downloaded from cameras located at exit lanes of car parks, such as camera 109. The table comprises several fields, such as exit ID field 721, exit registration number field 722, exit time field 723, exit location field 724, and exit image field 725, which is a pointer to one of files 311.

Entry and exit data from all the cameras is periodically downloaded into entry table 701 and exit table 702. Monitoring application 402 then matches up entry and exit records by vehicle registration number in order to provide parking records by populating parking table 703. When entry and exit records are matched, the information is transferred to a new record and parking table 703 and the records are deleted from table 701 and 702. Thus parking table 703 comprises several fields, including parking ID field 731, parking registration number field 732, parking entry time field 733, parking exit time field 734, parking location field 735, parking images field 736, and parking charged field 737, which is a boolean field used to indicate whether this record has been used to create a charge notice. An indication of time stayed in the car park is provided by determining the difference between entry time field 733 and exit time field 734. Alternatively, the time stayed can be explicitly calculated and stored. In either case, each parking record contains an indication of a time stayed.

The database described herein is only one method of storing entry and exit records and parking records. In other embodiments, parking records could be created by creating a linked list between entry records and exit records. Entry. and exit data could be stored in the same table, or exit data could be entered into the entry table. Any method of creating a single parking record showing the entry and exit time of a vehicle from an entry record and an exit record could be used.

In this embodiment, information in time fields is stored in a format that includes the time and the date. Each of the payment devices and camera systems synchronises its time with the atomic clock via an NTP server over Internet 214. In this example, central server 201 and payment servers 212 and 213 synchronise every twenty-four hours with the NTP server, and each pay-and-display machine synchronises every twenty-four hours with its respective payment server. Each camera synchronises every sixty seconds with the NTP server. Thus at any time each device in the system has an accurate time, including adjustment for daylight saving.

Data from pay-and-display machines such as machines 110, 208, 209, 210 and 211 is periodically downloaded using SQL queries from payment servers such as payment server 212 and 213 into payment table 704. Table 704 includes several fields, such as payment ID field 741, payment registration number field 742, payment time field 743, payment location field 744, payment duration field 745 and payment fee field 746. Thus payment table 704 contains a plurality of records, each indicating a vehicle registration number, the time that the machine was used and the location at which it stands, the duration which was paid for and the fee which was paid. Alternatively, the information provided may be the prescribed exit time for the vehicle instead of a duration, in which case the paid-for duration can be obtained by calculating the difference between the prescribed exit time and the time 743 at which the ticket was bought. In either case, each payment record contains an indication of a period of time corresponding to a fee paid.

Once parking table 703 is populated and payment data has been downloaded into payment table 704, monitoring application 402 then matches up payment records and parking records by vehicle registration number, each match resulting in a record in links list table 705, which links parking ID 731 with payment ID 741. Once the records are matched, it is possible to check whether a vehicle exceeded the time it was authorised to stay in a car park. Records relating to vehicles that do not contravene local parking regulations are archived to further tables (not shown) in the database. Records relating to vehicles which did contravene local parking regulations are used to create a contravention file which is sent to a notice processing server 216. These records are then also archived. Eventually, the tables 701 to 705 will be empty and downloading and processing of the next batch of data can be performed.

With slight modifications, application 402 could be used to monitor other types of vehicle use. For example, the system could be used to monitor the speed of vehicles on a road. Entry data would record the sight of a vehicle at a first camera and exit data would record the sight of the vehicle at a second camera. Parking regulations would be replaced by local road regulations, indicating the distance between the cameras and the speed at which vehicles are permitted to travel. By matching entry and exit records and applying the local road regulations, cars that, on average, exceed the speed limit could be noted. Similarly, the system could monitor toll roads or congestion zones by noting the entry and exit point onto the road of a vehicle and checking that the use has been paid for.

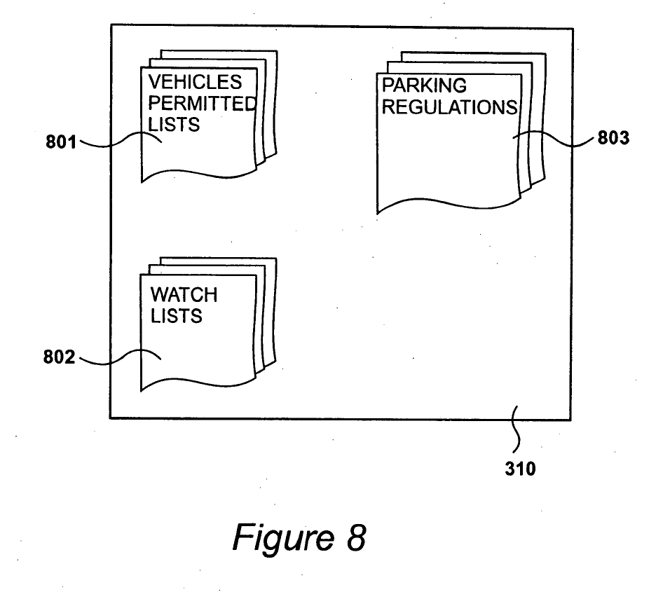

### FIG. 8

FIG. 8 shows files 310 stored on disk array 303 for use by monitoring application 402. They include vehicles permitted lists 801, each of which being a file relating to a single car park that includes registration numbers of vehicles that are permitted to park there under different regulations from other vehicles. Thus, for example, they may be permitted to park longer than the maximum stay, they may be permitted to park for free, and so on. Each list may also have indications of times of day or days of the week when the permit is applicable, which may be different for each vehicle registration number on the list.

Watch lists 802 are lists of vehicle registration numbers that are not permitted to park in certain car parks, or that are wanted by local authorities, and so on. There. may be a separate list for each site, or there may be lists in use by all sites. These lists are sent to the camera systems so that if one of these cars is seen the local authorities can be alerted immediately, rather than waiting for the next periodic download of data by central server 201. Alerts can be sent by any appropriate method over the Internet 214, for example SMS, email, screen-based alert on a terminal, and so on. Alternatively, local direct action can be taken such as the lowering of a barrier to prevent entry to or exit from the car parking site. At each camera system one or more list may be stored on the local server, or in a camera's memory or storage.

Parking regulations files 803 contain the local regulations for each site being monitored. Each file covers a different site and lists, for example, the times of days and days of the week when parking should be paid for, the maximum stay in a car park, the minimum period allowed before return of a vehicle to the car park, the cost of parking, the allowed period for making payment after entry into the car park, the grace period allowed for exit from a car park after the authorised duration has been exceeded, and so on. Parking regulations will vary considerably between sites but each parking regulations file is written in an agreed format that can be read by monitoring application 402 and used to determine what the local regulations are for a vehicle observed as a particular site at a particular time and date.

### FIG. 9

FIG. 9 details steps carried out by monitoring application 402 to monitor the parking at various car parking sites. At step 901 all the data from entry cameras at all sites is downloaded into entry table 701, and at step 902 all exit from exit cameras at all sites is downloaded into exit table 702. Camera data is in CSV format which can be used to populate the entry and exit tables, along with JPEG images which are saved as image files 502, with pointers to the file locations in the tables. At step 903 all payment data is downloaded from the payment servers. This is in the form of an SQL query, and SQL data is imported directly into payment table 704.

At step 904 parking table 703 is created using the data in entry table 701 and exit table 702. At step 905 parking table 703 is sorted by parking location field 735, and payment table 704 is sorted by payment location field 744.

At step 906 parking records in parking table 703 that contain registration numbers on the relevant vehicles permitted list 801 are archived from the table. At step 907 parking records in parking table 703 are matched by vehicle registration number with payment records in payment table 704 by creating links list table 705. The parking and payment records are then analysed to determine if any contravene local parking regulations, and archives.

At step 909 the application waits until a specified time before returning to step 901 and downloading data again. In this embodiment the system is set to download data every day at midnight However, downloading could occur more or less frequently than this, or it could occur only when the central server 201 is idle. If the download from any particular camera system or payment server is interrupted, the downloaded data will be deleted and the is download will be reattempted. Each camera system will delete the data once it has been successfully down loaded. Each payment server will archive the data once it has been successfully downloaded.

If a payment server indicates to central server 201, that a particular pay-and-display machine is out of service, then exit and entry data corresponding to that location will be archived and not processed. Similarly, if a camera system informs central server 201 that an entry or an exit camera is not working, then the data from the other camera will be archived and not processed.

Thus central server 201 is configured to receive entry data 701 containing at least one entry record, wherein each entry record contains a vehicle registration number 712 and an entry time 713, and receive exit data 702 containing at least one exit record, wherein each exit record contains a vehicle registration number 722 and an exit time 723. Central server 201 matches entry and exit records that have the same vehicle registration number to produce at least one parking record, wherein each parking record contains a vehicle registration number 732 and an indication of a period of time stayed in said car park obtained by determining the difference between parking entry time 733 and parking exit time 734. Central server 201 receives payment data 704 containing at. least one payment record, wherein each payment record contains a vehicle registration number 742 and an indication 745 of a period of time corresponding to a fee paid. For each parking record, central server 201 either identifies a payment record that has the same vehicle registration number and determine whether the indication of time stayed exceeds the indication of time paid for in said identified payment record, or identifies a condition to the effect that there is no matching payment record.

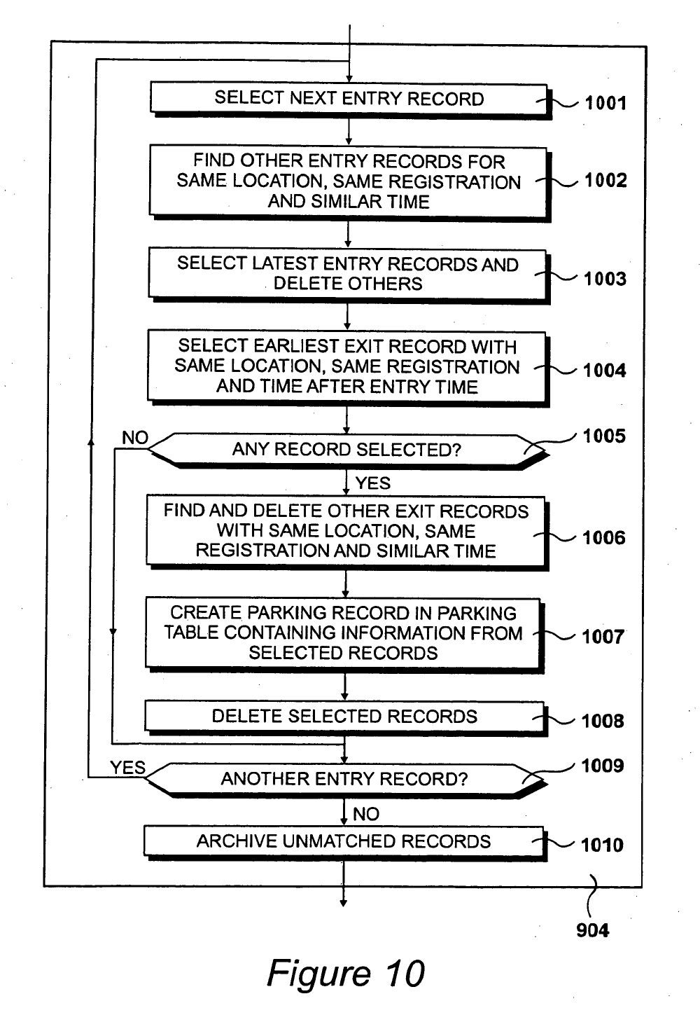

### FIG. 10

FIG. 10 details step 904 at which parking table 703 is created from the data in entry table 701 and exit table 702. At step 1001 the first entry record in entry table 701 is selected and at step 1002 other entry records having the same information in location field 714, the same information in registration field 712, and a similar time in entry time field 713 are found. The purpose of this is to find multiple captures of the same vehicle registration plates that correspond to only a single vehicle entry to the car park. This can occur for example, when vehicles are queuing or if an object such as a person intrudes between the camera and the number plate while the vehicle is entering the car park.

Thus the method of finding records with a similar time for the selected record may be finding records that have a time within a specified period, for example five minutes, of the time in the selected record; it may be finding a number of records, none of which have a time more than, for example, a minute difference from at least one other record. Other algorithms may be used. However they are found, at step 1003 the record having the latest entry time is selected and the others are deleted.

At step 1004 the exit record in exit table 702 that has the same information in location field 724 as the entry record, the same information in registration number field 722 as the entry record, and having an exit time that is after the entry time of the. selected entry record but is the earliest of any such records. At step 1005 a question is asked as to whether such a record is selected and if this question is answered in the negative then there is no exit record matching the selected entry record and no further processing of the entry record is carried out.

If the question. is answered in the affirmative, to the effect that the record has been selected, then at step 1006 any further exit records having the same location, same registration number and a similar time to the selected exit record are found are deleted. The same algorithm for finding records with similar times may be used.

Thus where there are multiple entry records for the same vehicle the latest of these is used, and where there are multiple exit records for the same vehicle the earliest of these is used. This gives the shortest possible parking duration for a vehicle and ensures that drivers are not penalised for time they spend queuing to enter or exit a car park. However, the system could be set up, to select one of a plurality of similar records differently. For example, in an average-speed calculation system the longest possible duration would give a fairer result. Alternatively the middle one might be taken in order to provide a compromise. Any method of selecting a single record from a number of records that clearly relate to the same entrance or exit of the same vehicle could be used.

At step 1007 a parking record is created in parking table 703 containing the information from the selected entry record and the selected exit record and at step 1008 the selected records are deleted. At step 1009 a question is asked as to whether there is another entry record in entry table 701, and if this question is answered in the affirmative then control is returned to step 1001 and the next record is selected. Alternatively, if all the entry records have been processed then at step 1010 any unmatched entry or exit records are archived. For any vehicle, if there is only a record of it leaving or entering the car park then its parking duration cannot be calculated. However, these unmatched records are archived rather than deleted so that statistics on the number of unmatched records can be calculated. If a particular site starts producing a large number of unmatched records then it is likely that some form of intervention is needed by the administrators of the system; for example, tailgating may be preventing vehicle registration number plates from being seen, a camera may be badly sited or faulty, and so on.

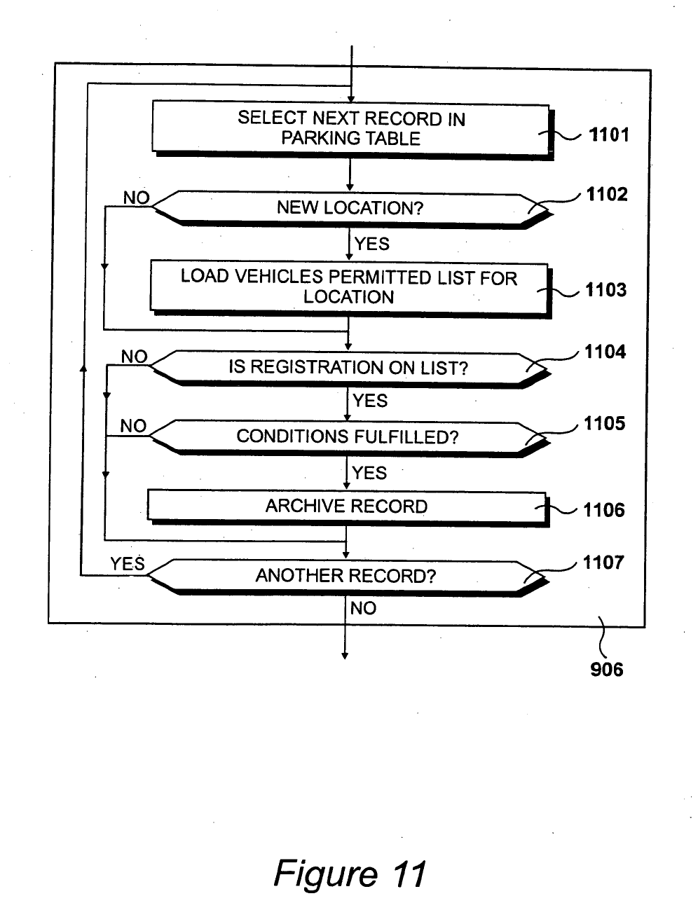

### FIG. 11

FIG. 11 details step 906 at which parking records in parking table 703 that relate to vehicles that are permitted to park in a particular car park are identified.

At step 1101 the first record in parking table 703 is selected and a question is asked as to whether the location in location field 735 is different from on the previous iteration. On the first iteration this will be answered in the affirmative. On subsequent iterations the question will only be answered in the affirmative when all records for the same location have been processed, because parking table 703 is sorted by location field 735. If the question is answered in the affirmative the vehicles permitted list for that location is selected from lists 801 and loaded at step 1103 into memory 302. The list contains registration numbers of vehicles that are allowed to park in the specified car park for longer or for less payment than other vehicles.

At step 1104 a question is asked as to whether the vehicle registration contained in registration field 732 of the selected record is contained in the loaded list. If this question is answered in the affirmative then at step 1105 a further question is asked as to whether any conditions of permitted parking specified in the list are fulfilled. For example, the vehicle may be permitted to park for a maximum number of hours, at specified times of day or days of the week, and so on. If this question is also answered in the affirmative then at step 1106 the record is archived because no further processing is required. However, if either of the questions asked at steps 1105 or 1106 is answered in the negative then the vehicle is either not on the list or it has not fulfilled the conditions and thus it will be treated as a normal vehicle.

At step 1107 a question is asked as to whether there is another record in entry table 701, and if this question is answered in the affirmative control is returned to step 1101 and the next record is selected. Alternatively, all records have been checked against the vehicles permitted lists 801 and step 906 is completed.

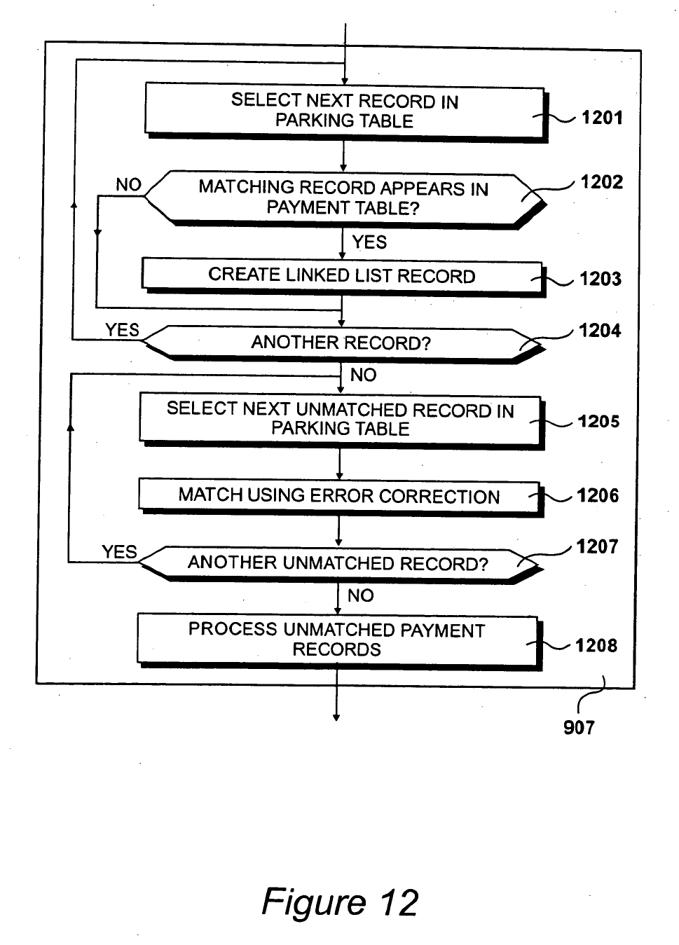

### FIG. 12

FIG. 12 details step 907 at which parking records in parking table 703 are matched with payment records in payment table 704. At step 1201 the first record in parking table 703 is selected and at step 1202 a question is asked as to whether there is a matching record in payment table 1202. Matching records have the same information in registration number fields 732 and 742 and in location fields 735 and 744, and substantially the same information in entry field 733 and payment time field 743. In this embodiment, times that are within fifteen minutes of each other are considered to be substantially the same, since a driver is typically allowed fifteen minutes from entry to park and obtain a ticket, but other methods of determining this could be used.

If this question is answered in the affirmative, to the effect that a matching record has been found, then at step 1203 a record in linked list table 705 is created, containing the parking ID 731 and payment ID 741 of the matched records. Following this, or if the question asked at step 1202 is answered in the negative, then at step 1204 a question is asked as to whether there is another record in parking table 703. If this question is answered in the affirmative control is returned to step 1201 and the next record is selected, whereas if it is answered in the negative then all the parking records have been processed.

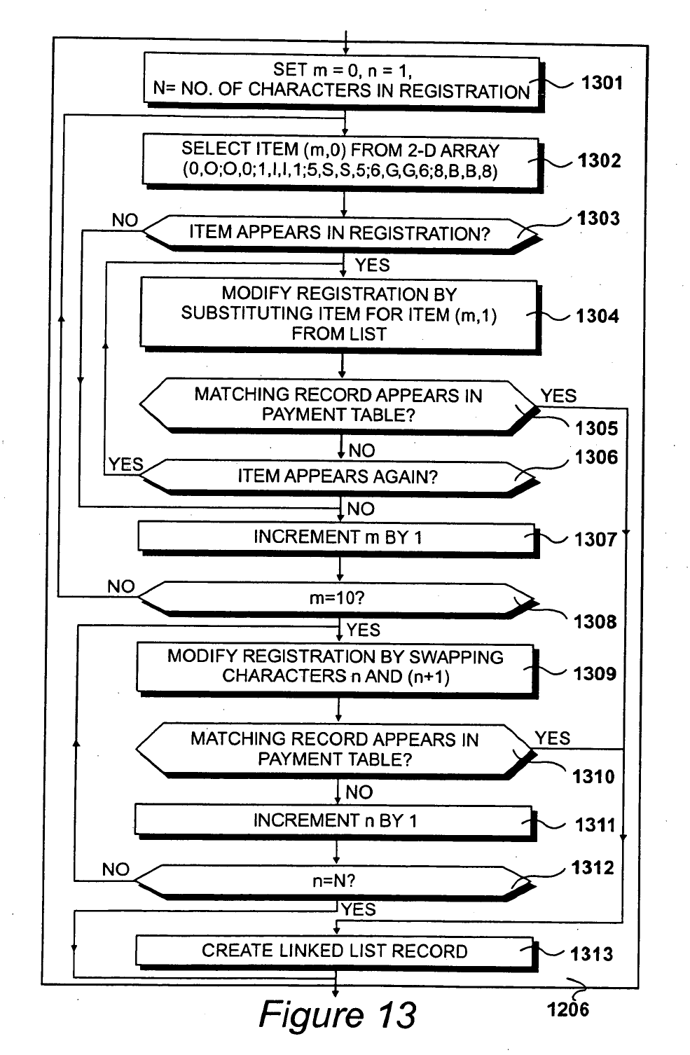

Following the completion of all the iterations of steps 1201 to 1204, a number of parking records and payment records may remain unmatched. Many drivers make errors when entering the registration number into a pay-and-display machine and thus a certain amount of error-correction can be performed in order to match more parking and payment records. Thus at step 1205 the first unmatched record in parking table 703 is selected and at step 1206 an attempt is made to match it using error correction, as will be described further with respect to FIG. 13. At step 1207 a question is asked as to whether there is another unmatched record and if this question is answered in the affirmative control is returned to step 1205 and the next unmatched record is selected. Alternatively, it is answered in the negative and all the unmatched records have been processed.

Following the completion of step 907, there may still be some unmatched parking records. These may relate to vehicles for which no payment was made. However, if there are also still some unmatched payment records then at the discretion of the administration it is possible to look at the entry and payment times and attempt to match them up. Alternatively, the view may be taken that if the driver did not enter the registration number or entered it so incorrectly that the error-correction process could not match it, a contravention of local parking regulations has occurred. Thus at step 1208 unmatched payment regulations are processed in some way, for example by performing more attempts at matching them with parking records, or by archiving them as unmatched records.

### FIG. 13

FIG. 13 details step 1206 during which error-correction on an unmatched parking record is performed. In this embodiment, the two most common errors of substitution and swapping are checked for. The most frequent substitution errors are made by substituting one character of the following pairs for the corresponding character 0 and O, 1 and I, 5 and S, 6 and G, and 8 and B. The most frequent swapping errors are made by swapping adjacent characters. It is assumed that errors are made by the driver of a vehicle and not by the ANPR cameras.

At step 1301 three variables are set: a variable m is set to zero, a variable n is set to zero, and a variable N is set to be the number of characters. in the registration number in registration. number field 732 of the selected parking record. At step 1302 the item in position m in an array of the above-mentioned frequently-substituted characters is selected (zero being the first position), and at step 1303 a question is asked as to whether this item appears in the registration number. If this question is answered in the affirmative then at step 1304 the registration number is modified by substituting this character for its paired character, eg substituting O for 0 in the first iteration. A question is asked as to whether a matching record appears in payment table 704, in the same way as at step 1202 except that it is the modified registration number that should match the number in registration number field 742. If this question is answered in the affirmative then at step 1313 a record in linked list table 705 and error-correction step 1206 is over.

If the question asked at step 1305 is answered in the negative, to the effect that no matching record is found, then at step 1306 a question is asked as to whether the item appears again in the registration number. If this question is answered in the affirmative then control is returned to step 1304 and the registration number is modified again. If it is answered in the negative then at step 1307 the variable m is incremented by 1 and at step 1308 a question is asked as to whether m is now equal to ten. If this question is answered in. the affirmative then all the frequently-substituted characters have been attempted; if it is answered in the negative then control is returned to step 1302 and the next item is selected.

If error-correction of substitution is unsuccessful in matching a payment record then error-correction of swapping is tried. At step 1309 the registration number is modified by swapping. the characters in position n and (n+1); on the first iteration this is the first two characters, on the second iteration this is the second and third characters, and so on. At step 1310 a question is asked as to whether a matching record appears in payment table 704 for this modified registration number, and if this question is answered in the affirmative then at step 1313 a record in linked list table 705 and error-correction step 1206 is over.

If it is answered in the negative then at step 1311 n is incremented by 1 and a question is asked at step 1312 as to whether n is now equal to N. if this question is answered in the negative then control is returned to step 1309 and the next two characters are swapped. If it is answered in the affirmative then all error-correction has been tried and step 1206 is completed.

Thus, for example, a vehicle having registration number YO56 PRJ may be incorrectly entered as Y0S6 PRJ, as shown in FIG. 6. During the application of the above algorithm, a parking record having YOS6 PRJ in the registration number field 742 would be discovered and matched with the parking record. Similarly, if the driver entered YO56 RPJ this would also be matched. Other error-correction algorithms may be used, but a compromise should be made between leniency to mistakes and processing time.

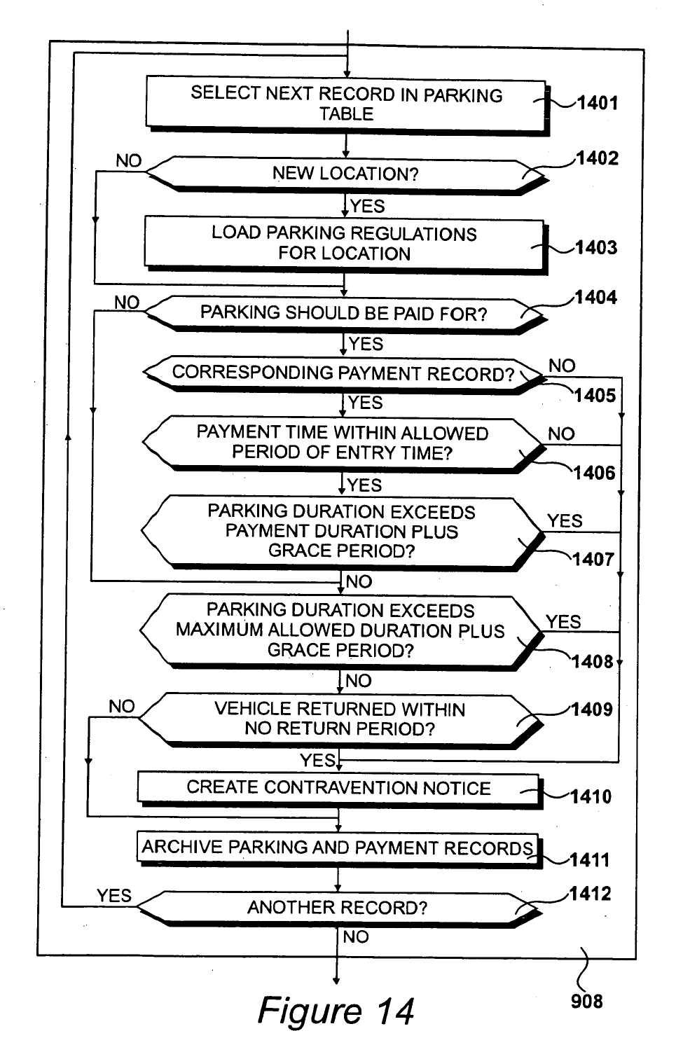

### FIG. 14

FIG. 14 details step 908 at which the parking records in parking table 703 are analysed to discover whether vehicles were parked in contravention of local parking regulations. At step 1401 the first record in the parking table 703 is selected and at step 1402 a question is asked as to whether the location in location field 735 is different from on the previous iteration. On the first iteration this will be answered in the affirmative. On subsequent iterations the question will only be answered in the affirmative when all records for the same location have been processed, because parking table 703 is sorted by location field 735. If the question is answered in the affirmative then at step 1403 the parking regulations file for the location is loaded into memory 302. The file is in XML format that allows it to be processed in conjunction with parking and payment records.

At step 1404 a question is asked as to whether the parking should be paid for, according to the parking regulations file. If the location is not a pay-and-display car park, or if the entry time 733 and exit time 734 both fall within a period when payment is not required, for example overnight, on a Sunday or Bank Holiday, and so on, then this question is answered in the negative and control is directed to step 1408.

If it is answered in the affirmative then at step 1405 a question is asked as to whether there is a matched payment record, as shown in linked list table 705. If this question is answered in the affirmative then at step 1406 a question is asked as to whether the payment time 743 is within an allowed period (specified in the regulations) of the parking entry time 733. If this question is answered in the affirmative then at step 1407 a question is asked as to whether the parking duration, indicated by the difference between the exit time 734 and entry time 733, exceeds the payment duration 745 that was paid for, plus any grace period indicated in the regulations.

If this question or the question asked at step 1404 is answered in the negative, then at step 1408 a question is asked as to whether the parking duration exceeds the maximum parking allowed plus any grace period, as laid down in the regulations. If this question is answered in the negative then a final question is asked as to whether the vehicle returned within a no-return period, if any, specified in the regulations. This involves searching parking records 703 for a record matching the registration number 732 and the location 735 for which the difference between the entry time 733 and the exit time 734 of the current record is less than the no-return period.

If this question is answered in the negative then no parking contravention occurred. However, if either of the questions asked at steps 1405 or 1406 is answered in the negative, or if either of the questions asked at steps 1407 or 1408 is answered in the affirmative, then a charge notice. is created at step 1410. In either case, the relevant parking and payment records are archived at step 1411.

Archived records can be analysed to produce statistics regarding car park use. For example, a car parking site owner may wish to know when the site is being most used, how long vehicles stay for, and so on. In addition, car parking regulations can be dynamically updated based on statistics. For example, at peak parking times of year such as Christmas it is possible that drivers may unintentionally exceed the amount of time permissible between entering and paying, or the grace period between expiry of the period paid for and actual exit time. When certain statistics go over a certain threshold ft can trigger an automatic change in the parking regulations to take account of this. As another example, low usage could trigger lowering of parking charges, or high usage at certain times of day could trigger higher prices at those times. in this example, these price changes should be made available to drivers, for example via an electronic display on the pay-and-display machine, or via information on a phone line if a telephone is being used as a payment device. As another example, at peak times certain vehicles on the permitted list might no longer be permitted to park for free. Thus any or all parking regulations or conditions of the permitted list can be automatically or manually changed, either in response to analysis of statistics or in response to other events.

At step 1412 a question is asked as to whether there is another record in parking table 703 and if this question is answered in the affirmative control is returned to step 1401 and the next record is selected. If it is answered in the negative then step 908 is completed. All parking and payment records have been archived and any parking records that relate to a contravention of local parking regulations have been dealt with appropriately.

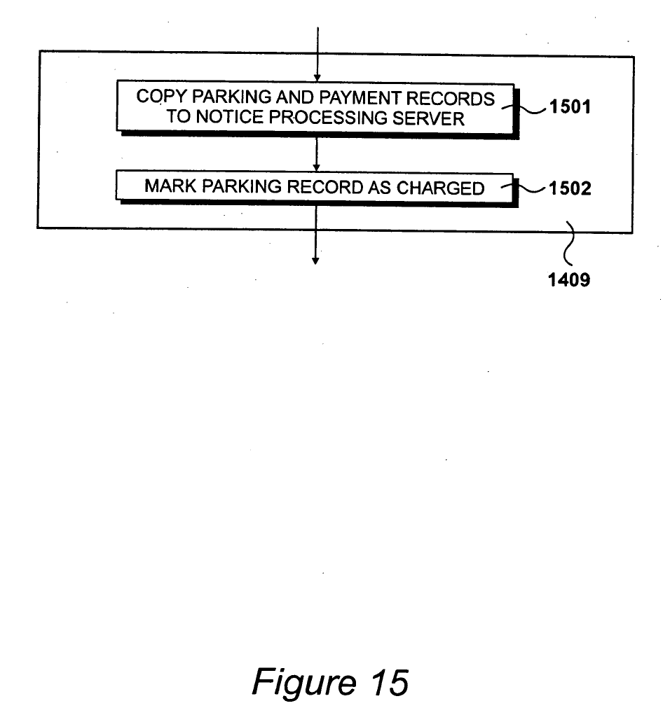

### FIG. 15

FIG. 15 details step 1409 at which a charge notice is created. At step 1501 the information in the parking record and any associated payment record is sent to notice processing server 216, in this example as an XML file. At step 1502 the parking record is marked as processed in field 737.

Notice processing server 216 is configured to send a request to the relevant vehicle licensing authority for registered keeper details. This request is received by vehicle licensing server 215 which forwards the details as requested. Notice processing server 216 may use the parking information and registered keeper details to produce a charge notice, which could be a demand for payment of an excess charge, a simple indication that parking regulations were contravened, or some other type of notice.

What is claimed is:

1. Apparatus for monitoring a car park, comprising a processor, memory, storage and a network connection, wherein said processor is configured to:
receive entry data containing at least one entry record, wherein each entry record contains a vehicle registration number and a time;
receive exit data containing at least one exit record, wherein each exit record contains a vehicle registration number and a time;
match entry and exit records that have the same vehicle registration number to produce at least one parking record, wherein each parking record contains a vehicle registration number and an indication of a period of time stayed in said car park;
receive payment data containing at least one payment record, wherein each payment record contains a vehicle registration number and an indication of a period of time corresponding to a fee paid; and
for each parking record, one of:
identify a payment record that has the same vehicle registration number and determine whether said indication of time stayed exceeds said indication of time paid for in said identified payment record, and
identify a condition to the effect that there is no matching payment record.

2. Apparatus according to claim 1, wherein said apparatus is configured to monitor a plurality of car parking sites and each of said entry records, exit records and payment records additionally includes a location.

3. Apparatus according to claim 2, wherein said payment data is produced by at least one payment device having a payment processor, a manual input device, a payment device, an output and a network connection, wherein said payment processor is configured to:
receive a vehicle registration number from said manual input device;
determine a fee paid to said payment device;
calculate an assigned exit time corresponding to said fee;
output said assigned exit time to said output device; and
output said vehicle registration number and said assigned exit time via said network connection.

4. Apparatus according to claim 2, wherein said processor is configured to produce each parking record by:
selecting a first record containing a first registration number and a first time from a first set of records;
selecting a second record containing said first registration number and a second time from a second set of records, wherein said second set does not intersect with said first set;
creating a parking record containing said first registration number, said first time and said second time; and
deleting said first and second records, wherein one of:
said first set of records comprises entry records and said second set of records comprises exit records, and
said first set of records comprises exit records and said second set of records comprises entry records.

5. Apparatus according to claim 4, wherein said processor is configured to select a first record by:
identifying a plurality of records in said first set that contain said first vehicle registration number and times that are within a specified duration of each other,
selecting one of said identified plurality of records; and
deleting the rest of said identified plurality of records.

6. Apparatus according to claim 5, wherein said processor is configured to identify only records from the first set containing the same location.

7. Apparatus according to claim 1, wherein said processor is further configured, upon identifying a condition to the effect that, for a first parking record containing a first vehicle registration number, none of said payment records contains said first vehicle registration number, to:
modify said first vehicle registration number to create a modified first vehicle registration number; and
attempt to identify a payment record that contains said modified vehicle registration number.

8. Apparatus according to claim 7, wherein said processor is configured to modify said first vehicle registration number by substituting a character in said registration number for another character.

9. Apparatus according to claim 7, wherein said processor is configured to modify said first vehicle registration number by swapping the positions of two adjacent characters in said registration number.

10. Apparatus according to claim 1, wherein said entry data and said exit data are downloaded periodically from a server connected to at least one automatic number plate recognition camera.

11. A method of monitoring car parking, comprising the steps of:
obtaining entry data containing at least one entry record, wherein each entry record contains a vehicle registration number, a location and a time;
obtaining exit data containing at least one exit record, wherein each exit record contains a vehicle registration number, a location and a time;
matching entry and exit records that have the same vehicle registration number to produce at least one parking record, wherein each parking record contains a vehicle registration number and an indication of a time stayed;
obtaining payment data containing at least one payment record, wherein each payment record contains a vehicle registration number and an indication of a period of time corresponding to a fee paid; and
for each parking record, attempting to identify a payment record that has the same vehicle registration number and, if a payment record is identified, determining whether said indication of time stayed exceeds the period of time paid for in said identified payment record.

12. A method according to claim 11, wherein a plurality of car parking sites are monitored and each of said entry records, exit records and payment records additionally includes a location.

13. A method according to claim 12, wherein said step of obtaining payment data comprises the steps of:
at a payment device:
receiving an indication of a vehicle registration number;
receiving a fee;
calculating a period of time corresponding to said fee;
producing an indication of said period of time;
storing said vehicle registration number and said period of time as payment data; and
at a central server, obtaining said payment data from said payment device.

14. A method according to claim 11, wherein said step of producing at least one parking record comprises the steps of:
identifying a first record containing a first registration number and a first time from a first set of records;
identifying a second record containing said first registration number and a second time from a second set of records, wherein said second set does not intersect with said first set;
creating a parking record containing said first registration number, said first time and said second time; and
deleting said identified first and second records, wherein one of:
said first set of records comprises entry records and said second set of records comprises exit records, and
said first set of records comprises exit records and said second set of records comprises entry records.

15. A method according to claim 14, further comprising the steps of:
identifying a plurality of records in said first set that contain said first vehicle registration number and times that are within a specified duration of each other;
selecting one of said identified plurality of records; and
deleting the rest of said identified plurality of records.

16. A method according to claim 11, further comprising the steps of:
identifying a condition to the effect that, for a first parking record containing a first vehicle registration number, none of said payment records contains said first vehicle registration number;
modifying said first vehicle registration number to create a modified first vehicle registration number; and
identifying a payment record that contains said modified vehicle registration number.

17. A computer-readable medium having computer-readable instructions thereon, wherein said instructions configure a computer to carry out the steps of:
receiving entry data containing at least one entry record, wherein each entry record contains a vehicle registration number and a time;
receiving exit data containing at least one exit record, wherein each exit record contains a vehicle registration number and a time;
matching entry and exit records that have the same vehicle registration number to produce at least one parking record, wherein each parking record contains a vehicle registration number and an indication of a period of time stayed in said car park;
receiving payment data containing at least one payment record, wherein each payment record contains a vehicle registration number and an indication of a period of time corresponding to a fee paid; and
for each parking record, one of:
identifying a payment record that has the same vehicle registration number and determine whether said indication of time stayed exceeds said indication of time paid for in said identified payment record, and
identifying a condition to the effect that there is no matching payment record.

18. A computer-readable medium according to claim 17, wherein said instructions configure said computer to monitor a plurality of car parking sites and each of said entry records, exit records and payment records additionally includes a location.

19. A computer-readable medium according to claim 17, wherein said step of producing at least one parking record comprises the steps of:
identifying a first record containing a first registration number and a first time from a first set of records;
identifying a second record containing said first registration number and a second time from a second set of records, wherein said second set does not intersect with said first set;
creating a parking record containing said first registration number, said first time and said second time; and
deleting said identified first and second records, wherein one of:
said first set of records comprises entry records and said second set of records comprises exit records, and
said first set of records comprises exit records and said second set of records comprises entry records.

20. A computer-readable medium according to claim 19, wherein said instructions configure said computer to select a first record by:
identifying a plurality of records in said first set that contain said first vehicle registration number and times that are within a specified duration of each other,
selecting one of said identified plurality of records; and
deleting the rest of said identified plurality of records.

21. A computer-readable medium according to claim 17, wherein said instructions further configure said computer to, upon identifying a condition to the effect that, for a first parking record containing a first vehicle registration number, none of said payment records contains said first vehicle registration number:
modify said first vehicle registration number to create a modified first vehicle registration number; and
attempt to identify a payment record that contains said modified vehicle registration number.
